(19) United States
(12) Patent Application Publication
(10) Pub. No.: US 2011/0198208 A1
(43) Pub. Date: Aug. 18, 2011

(54) METHOD FOR DESALINATING WATER CONTAINING SALT

(75) Inventors: Ralf Olwig, Koln (DE); Christian Sattler, Bonn (DE); Klaus Hennecke, Lohmar (DE); Klaus Pottler, Aguadulce(Almeria) (ES)

(73) Assignee: Deutsches Zentrum Fur Luft-Und Raumfahrt E.V., Koln (DE)

(21) Appl. No.: 13/124,819

(22) PCT Filed: Oct. 30, 2009
(86) PCT No.: PCT/EP09/64370

§ 371 Date: Apr. 18, 2011

(51) Int. Cl. C02F 1/14; B01D 3/00; C02F 103/08

(52) U.S. Cl. 203/10; 202/167

(57) ABSTRACT

For desalinating saline water, a solar energy collector plant comprising parabolic trough collectors is used as a heat generator. With the generated heat, a heat engine is driven by steam, wherein the heat engine drives a generator to generate electricity. The residual steam of the heat engine is used to heat a distillation device in which a first partial flow of the saline water is distilled. A second partial flow of the saline water is fed to a reverse osmosis device that is supplied with the electricity of the generator to generate pressure. After both partial flows are desalinated or partially desalinated, the two partial flows are mixed in a mixing device which thereby produces drinking water.

The invention relates to a method for desalinating saline water by use of solar energy, and a sea-water desalination plant.

Desalination plants are largely used for desalinating sea water having a high salt content in order to generate drinking water. Common use is made of thermally operated desalination plants comprising a distillation device which is operative to vaporize the saline water. Such distillation devices have a high energy consumption but are also suited for high desalination capacities as required for water supply to the general public.

Already known are reverse osmosis systems which are also referred to as RO systems (reverse osmosis). Such systems comprise a semipermeable membrane arranged to separate several chambers from each other. The highly salty water (e.g. sea water) is forced through the semipermeable membrane with high pressure. The permeate will be in a condition ranging from an only slightly salty state to a drinkable state. The retentate consists of concentrated sea water.

The energy consumption depends very much on the salt content (high salt content=high osmotic pressure to be overcome).

Various studies deal with solar desalination systems in which the energy for desalinating the water is obtained as solar energy. Such systems are referred to as CSPD (concentrating solar power & desalination plant) or as CSD (concentrating solar desalination plant).

It is an object of the invention to provide a method for desalinating saline water which can be practiced with high efficiency and is operable completely, or at least to a high extent, by cost-free solar energy. A further object of the invention resides in providing a corresponding sea-water desalination plant.

The method according to the invention is defined by claim 1, and a seawater desalination plant according to the invention is defined by claim 5.

The invention provides that, in a solar-powered desalination plant, a thermal desalination system and a reverse osmosis system (RO system) are combined with each other. The solar energy obtained as thermal energy is used for the operation of a heat engine, typically a steam turbine. The steam turbine will deliver, on the one hand, mechanical energy for rotating a generator so as to generate steam, and, on the other hand, it will deliver residual steam.

According to the invention, the mechanical or electric energy supplied by the heat engine is used for operating a reverse osmosis system, and the residual steam of the heat engine is used for operating a distillation device. Thus, a hybrid system is established wherein the heat engine is used to supply energy for two different types of desalination and, for this purpose, will provide electricity or pressure on the one hand, and steam or heat on the other hand. Since the energy supplied to the heat engine is used nearly to the full extent, the efficiency of the heat engine will not impose limits on the water production capacity. This makes it possible to use a heat engine of an inexpensive and durable type.

In thermal desalination, distilled water will be generated, and desalination by reverse osmosis will generate water with a low content of salt. By mixing the two partial flows, the content of salt or minerals can be brought to that of drinking water. Since, in the thermal system, salt-free water is generated, the reverse osmosis system is allowed to generate water with a higher salt content, e.g. above 500 r/min. Thus, the reverse osmosis system can be provided with high-flux membranes and be operated with high water temperatures and low energy consumption.

Preferably, the solar energy is collected with the aid of concentrating solar power technology (CSP) using parabolic troughs. In this approach, use is made of reflective parabolic troughs which in their focal line comprise an absorber tube for throughflow of a heat carrier medium, typically oil or water. Said heat carrier medium will transport the heat to a water-vapor circuit driving a heat engine. For a heat carrier medium, use can be made also of water that has already vaporized in the absorber tube, and the steam can then be used for driving a heat engine. When water is chosen as a heat carrier medium, this is referred to as direct steam generation (DSG).

It is possible to connect the water-vapor circuit of the heat engine to an auxiliary heat source which can be operated by fossil fuel. This will safeguard the availability of the required energy capacity also in case of insufficient solar radiation.

For desalination of sea water, use is made of thermal processes based on the principle of evaporation and condensation. Obtained from such processes is distilled water which is free of all dissolved ingredients and which in this form is not drinkable. By mixing the distilled water with the partially desalinated water leaving the reverse osmosis system, there is obtained drinking water having a salt content that can be determined and controlled by control of the mixing ratio.

The invention finds preferred application in large drinking-water treatment plants having a drinking water capacity of more than 1000 m³/day, particularly for desalination of sea water and brackish water. However, the invention is also applicable for agricultural purposes wherein a higher salt content is allowable, or for industrial purposes.

Distilling the water is preferably performed as a multi-effect distillation in vessels interconnected in a cascade-like configuration, wherein the steam generated in one vessel during distillation is used as a heat source for the distillation in the next vessel. Thus, the available heat can be exploited to a good extent so that the yield of the distillation process will be high.

For a cost-effective reverse osmosis desalination system (RO system), it is essential that the shaft power of the heat engine is generated with high efficiency. A high-temperature heat accumulator can be used so as to reduce the partial load operation of the energy converter and to generate electric energy during the night. Such a system could be operated as an independent solar-electricity or water generating system, or as a system for simultaneous generation of electricity and water. The design for dual use allows for a considerable reduction of the general costs for the generation of electricity and water. On the other hand, the direct production of freshwater by use of an integrated solar-water system has advantages. In addition to the offered possibilities of an optimization of the integrated system (as one complex), freshwater can be stored much more easily than electricity (or heat). Therefore, in case of solar-driven water production, the difficult problem of energy storage is solved in a simple fashion. The availability of solar radiation which is not uniform over the course of the day, and even less so due to changes of the weather, can thus be handled in a cost-effective manner. Further, it is possible to develop a hybrid desalination system wherein the reverse osmosis system uses the generated energy while the thermal distillation system uses the remaining waste heat so that the systems together produce water with a higher total efficiency. This can be of advantage particularly in medium-sized desalination systems (which are to be installed in small communities) for which no highly efficient steam turbines are available yet. To sum up, the production of freshwater by means of an integrated solar-water system is a promising technology.

An embodiment of the invention will be explained in greater detail hereunder with reference to the drawings.

In the drawings:

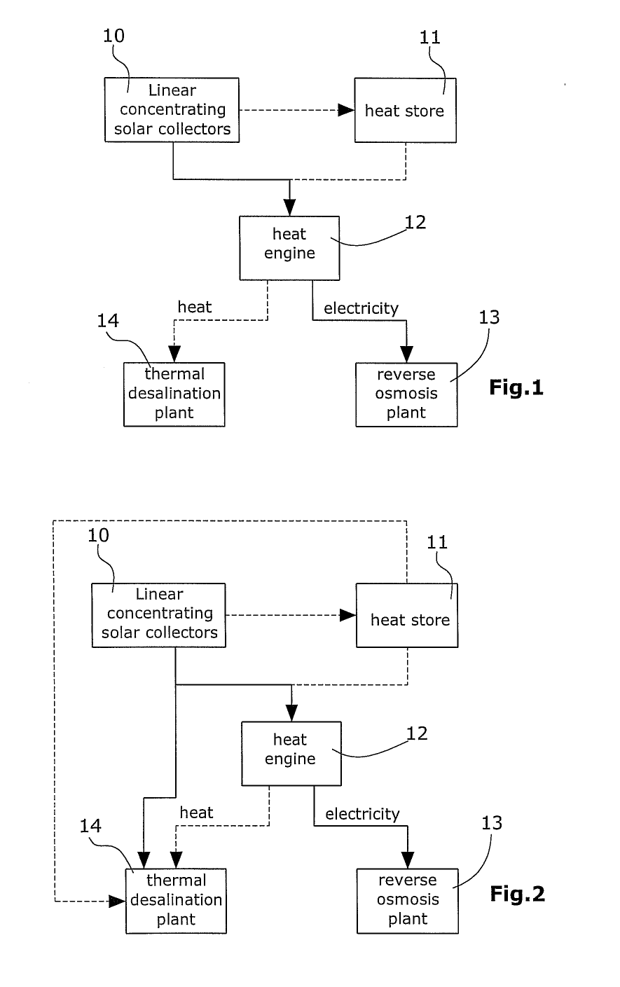

FIG. 1 is a schematic view of a desalination plant according to the present invention,

FIG. 2 is a schematic view of a desalination plant with added heat store,

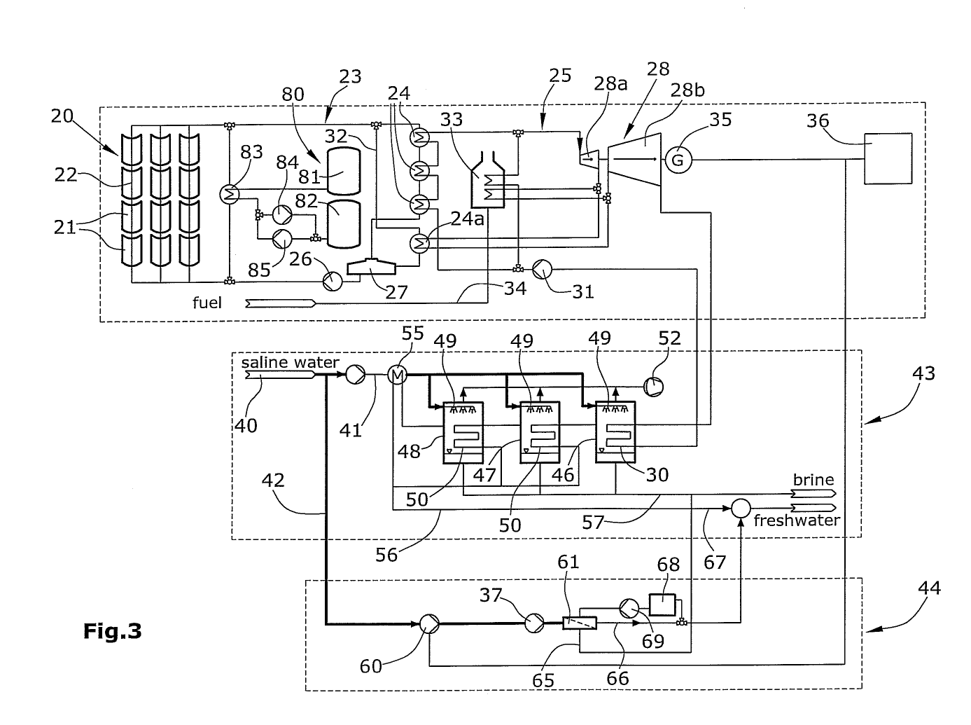

FIG. 3 is detailed diagram of the layout of a desalination plant, and

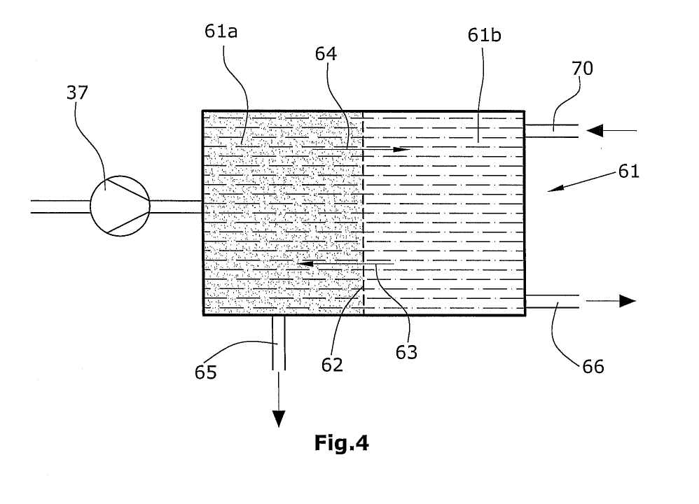

FIG. 4 is a view of the reverse osmosis device.

FIG. 1 shows the basic layout of a CSPD system (concentrating solar power & desalination) for generating freshwater. The solar energy is collected by linear concentrating solar collectors 10, particularly by parabolic trough collectors. In parallel arrangement thereto, heat stores 11 are provided for storage of excess heat which is not used during the day, so that this heat can be processed when required, e.g. in night-time operation.

The heat of the solar collectors 10 is used for operating a heat engine 12. The latter is a turbine, particularly a steam turbine, driving a generator for generating electricity. With the thus generated electricity, a reverse osmosis plant 13 is driven. The residual heat of the heat engine 12 is used for driving a thermal desalination plant or distilling plant 14. The distilling plant 14 as well as the reverse osmosis plant 13 generate salt-free and low-salt water, respectively. Subsequently, the two water flows can be combined or be mixed as required.

The exemplary embodiment according to FIG. 2 is generally similar to the first embodiment. Additionally, it is provided that heat from the heat store 11 or from the oil circuit of the collector plant is supplied immediately to the thermal desalination plant 14. In each of the exemplary embodiments shown in FIGS. 1 and 2, a part of the electricity generated by heat engine 12 can be branched off and be supplied e.g. into a power network.

FIG. 3 shows a detailed diagram of the desalination plant of FIG. 1. Provided as an energy source is a solar energy collector plant 20 comprising reflecting parabolic trough mirrors 21 arranged in line. The collectors, each comprising the parabolic trough mirror 21 and the absorber tube 22, can be moved to follow the position of the sun. The parabolic trough collectors 21 are operative to focus the incident sunlight onto absorber tubes 22 extending along the focal line. The absorber tubes are provided for throughflow of a heat carrier medium such as e.g. oil or water. The heat carrier medium is entered into a circuit 23 comprising a group of heat exchangers 24. The primary sides of the heat exchangers 24 are arranged in series within said circuit. The circuit further includes a pump 26 for circulating the heat carrier medium in the circuit, as well as an expansion vessel 27. Also the secondary sides of the heat exchangers 24 are arranged in series and are located in a water-vapor circuit 25. This circuit further includes the high-pressure section 28a of a heat engine 28 designed as a steam turbine, as well as the low-pressure section 28b, a heat exchanger 30 and a pump 31.

The outlet of said high-pressure section 28a is connected to the inlet of said low-pressure section 28b via a further heat exchanger 24a which is included in a bypass line 32 of circuit 23.

As a possible further energy source, a vessel 33 for fossil fuels is connected to the water-vapor circuit. Said vessel can be included in the process in order to support the steam generation. It is connected to a fuel line 34.

The heat engine 28 drives a generator 35 for generating electricity. Said generator is operative to supply electricity to a high-pressure pump 37, still to be described, and (optionally) to external consumers 36. Generator 35 delivers electricity not only to high-pressure pump 37 but also to all other pumps and facilities of the water desalination plant.

The salt water 40 is divided into two partial flows 41,42. A first partial flow 41 is supplied to a distillation device 43. A second partial flow 42 is supplied to a reverse osmosis device 44. The distillation device 43 comprises a plurality of vessels 46,47,48, each of them comprising, in its upper region, a spraying device 49 for spraying salt water within the vessel. The salt water will gather in the lower region of the vessel. Further, each vessel includes a heating coil 50 in order to introduce heat for the purpose of vaporizing the precipitating water. The heating coil 30 of the first vessel 46 is supplied with the residual water of the heat engine 28. The heating coils 50 of the two following vessels are each supplied with the steam which has been generated in the vessel connected upstream thereof. Such a cascade-like distillation is referred to as a multi-effect distillation (MED). An MED plant consists of a plurality (1 to n) of stages. The number of stages varies depending on the given design of the MED plants. In English-language usage, said stages are also called “effect”. A standard MED plant usually has eight (or even more) stages.

The vessels 46,47,48 are vacuum-tight. The vessels are connected to a vacuum pump 52 so that a pressure will be generated in them which is lower than the atmospheric pressure. For this reason, an evaporation of the precipitating water will occur already at temperatures below 100° C. Thus, for instance, the temperature will be 100° C. in vessel 46, 90° in vessel 47 and 80° C. in vessel 48. From the last vessel, the steam will delivered to a heat exchanger 55 where it will give off heat to said first partial flow 41 for preheating the same. The condensate consists of the condensed water which has been generated in all three vessels. It will be supplied to a conduit 56 as distilled, salt-free water. This water is not drinkable.

Arranged at the lower end of each vessel 46,47,48 is an outlet for the brine accumulating on the bottom of the vessel. These outlets are connected to a brine conduit 57 for discharging the brine.

The distillation device 43 forms the one part of the hybrid desalination plant. The other part is formed by the reverse osmosis plant 44 to which the second partial flow 42 is supplied. The reverse osmosis plant 44 includes a conveying pump 60, a high-pressure pump 37 and an osmosis module 61.

As shown in FIG. 4, said osmosis module comprises two chambers 61a and 61b. The two chambers are separated from each other by a semipermeable membrane 62. The high-pressure pump 37 conveys saline water into the first chamber 61a. When the concentration of salt in the first chamber 61a is higher than in the second chamber 61b, an osmotic pressure 63 is generated which is seeking to force the water through the membrane 62 into the first chamber. This tendency is counteracted by a hydrostatic pressure 64 generated by the high-pressure pump 37. This pressure causes water to flow into the second chamber 61b. At the same time, the concentration of salt in the first chamber 61a increases. The outlet 65 of the first chamber 61a is connected to the brine conduit 57. The outlet 66 of the second chamber 61b is connected to a mixing device 67 in which water having a low concentration of salt is mixed with the salt-free water from conduit 56. Mixing is performed in a controlled proportion to the effect that drinkable freshwater will be obtained at the outlet of mixing device 67.

Further, the reverse osmosis device includes a permeate reservoir 68 connected to outlet 66 and, via a pump 69, to the inlet 70 of second chamber 61b. Said permeate reservoir serves for subjecting the membrane to a cyclical backwash for cleaning and for prevention of depositions. This is required for protection of the membrane from an accumulation of depositions. Upstream of the MED plant, a chemical-mechanical pretreatment is provided. A common pretreatment can be performed before the division into said two partial flows 41 and 42. In this manner, a further synergy effect is achieved.

The solar energy collector plant 20 further includes a heat store 80 comprising a warm tank 81 and a cold tank 82. Both tanks contain a heat storage medium, e.g. liquid salt. The warm tank has a temperature>350° C. and the cold tank has a temperature<300° C. The tanks are connected to the circuit 23 via a heat exchanger 83 and include pumps 84,85 for selecting the flow direction of the salt, while suitable valves are provided for the purpose. Corresponding to the heat requirement of the consumers connected to the circuit 23 and the heat available from the solar radiation, excess heat can be fed into the heat store or missing heat can be taken from the heat store.

The desalination plant is suited to generate electricity by the heat engine 28 and the generator 35 and to produce water in the two partial flows 41 and 42. The ratio between the electricity generation capacity and the water production capacity can be varied in accordance with the respective local demand for water or in accordance with the respective demand for electricity.

1. A method for desalination of saline water by use of concentrated solar energy, said method comprising:
collecting solar energy by means of optical concentrators and transfer to a water-vapor circuit including a heat engine,
supplying a first partial flow of saline water to a thermal distillation device heated by residual steam of the heat engine, for distilling the water and discharging the salt in the form of brine,
supplying a second partial flow of saline water to a reverse osmosis plant powered by the electricity of the generator, for separating the saline water into water having a low salt concentration and brine.

2. The method according to claim 1, further comprising: mixing said water having a low salt concentration with the salt-free distillate obtained during distillation.

3. The method according to claim 1, wherein the distillation is performed as a multi-effect distillation in vessels interconnected in a cascade-like configuration.

4. The method according to claim 1, wherein the collecting of solar energy is performed by parabolic trough collectors or Fresnel collectors.

5. A water desalination plant comprising:
a solar energy collector plant with a heat carrier medium circulating therein,
a heat exchanger for transfer of heat from the heat carrier medium to a water-vapor circuit including a heat engine for driving an electricity-producing generator,
a thermal distillation device for distilling a first partial flow of saline water, said thermal distillation device being supplied with the residual steam of the heat engine for heating the same, and
a reverse osmosis plant powered by the electricity of the generator, for partial desalination of a second partial flow of saline water to generate water having a low salt content.

6. The water desalination plant according to claim 5, wherein a mixing device is provided for mixing the desalinated first partial flow and the partially desalinated second partial flow.

7. The water desalination plant according to claim 5, wherein the solar energy collector plant is coupled to a heat store.

8. The water desalination plant according to claim 5, wherein the water-vapor circuit is connected to an auxiliary heat source.

9. The water desalination plant according to claim 5, wherein the distillation device is a multi-effect device comprising a plurality of vessels interconnected in a cascade-like configuration, with saline water being supplied to each said vessels.

10. The water desalination plant according to claim 5, wherein the solar energy collector plant (20) comprises parabolic trough collectors (21) or Fresnel collectors.

11. The water desalination plant according to claim 5, wherein the generator feeds also other consumers, apart from the reverse osmosis plant.

12. The water desalination plant according to claim 5, comprising a device for chemical-mechanical pretreatment of the saline water, said device being arranged upstream of the division of the saline water into a first partial flow and a second partial flow.
